(19) United States
(12) Patent Application Publication
(10) Pub. No.: US 2008/0071601 A1
(43) Pub. Date: Mar. 20, 2008

(54) Account growth framework

(75) Inventors: Virgil Francis Cihla, Pekin, IL (US); Lawrence James Czernik, Bloomington, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/501,716

(22) Filed: Aug. 10, 2006

(51) Int. Cl. G07G 1/00

(52) U.S. Cl. 705/10

(57) ABSTRACT

Systems and methods are disclosed for managing customers who are either entering into or presently in a significant business growth cycle. In one embodiment, a sales manager and an account manager may analyze a customer profile. The customer profile may be based on data collected from the respective customer. The account manager may then select an AGF customer based on at least the analysis, and identify at least one business objective of the AGF customer. The account manager may further develop an AGF growth plan including a solution to help the AGF customer achieve the at least one business objective. The account manager may deliver the solution to the AGF customer according to the AGF growth plan and determine a value of the delivered solution in helping the AGF customer achieve the at least one business objective.

### TECHNICAL FIELD

The present disclosure generally relates to methods and systems for managing customer accounts, and more particularly to an account growth framework for strengthening relationships and increasing sales revenue with customers who are either entering into or presently in a significant business growth cycle.

### BACKGROUND

Customers use machines, e.g. trucks, loader, excavators, for projects of different scales. Depending on a customer's business activities and plans, the customer's spending on machines and services may fluctuate over time. Traditionally, a sales organization manages customer accounts by focusing on a customer's past business dealings. As a result, the sales organization often closely manages customer accounts with the most past spending.

Many systems and methodologies are developed to manage data related to customers and customer accounts. One approach to customer account management is to use a centralized customer information database to provide information from a variety of internal and external feeds. For example, U.S. Pat. No. 5,930,764 to Melchione et al. describes a system and method for identifying target customers using a centralized database to improve marketing success. The system includes a central database that receives comprehensive information from a variety of internal and external feeds, and standardizes and stores the information in a three-level hierarchy (households, customers, and accounts) for use by a financial institution. The comprehensive information stored on the central database is accessed through marketing workstations to generate lists of sales leads for marketing campaigns. A database engine is provided for generating logical access paths for accessing data on the central database to increase speed and efficiency of the central database. The system distributes sales leads electronically to branch networks, where the sales leads are used to target customers for marketing campaigns. The central database is accessed by workstations of a central customer information system for profiling customers, enhancing customer relationships with the financial institution, and electronically tracking sales and service performance during marketing campaigns.

While conventional systems and methods may be effective to some extent for managing customer accounts, they are often overly biased by a customer account's past spending records. Further, conventional systems often focus on a sales organization's own business objectives and performance goals, and therefore do not provide customer centric solutions tailored to meet customers' business objectives.

Therefore, there is a need to manage customer accounts based on projected future growth potential. Further, there is a need to focus on a customer's business growth objectives and deliver customer centric solutions. The disclosed embodiments improve upon prior art systems by providing a customer centric approach in managing a customer account's growth by helping customers achieve their business objectives.

### SUMMARY OF THE INVENTION

It is to be understood that both the foregoing general description and the following detailed description are exemplary and explanatory only and are not restrictive of the invention as claimed.

Systems and methods are disclosed for managing growth customer accounts. In one embodiment, a sales manager and an account manager may analyze a customer profile. The customer profile may be based on data collected from the respective customer. The account manager may then select an AGF (Account Growth Framework) customer based at least on the analysis, and identify at least one business objective of the AGF customer. The account manager may further develop an AGF growth plan including a solution to help the AGF customer achieve the at least one business objective. The account manager may deliver the solution to the AGF customer according to the AGF growth plan, and determine a value of the delivered solution in helping the AGF customer achieve the at least one business objective.

### BRIEF DESCRIPTION OF THE DRAWINGS

The accompanying drawings, which are incorporated in and constitute a part of this specification, illustrate exemplary embodiments of the invention and together with the description, serve to explain the principles of the invention. In the drawings:

FIG. 1 is a block diagram of an exemplary account management environment consistent with certain disclosed embodiments;

FIG. 2 is a block diagram of an exemplary account management architecture consistent with certain embodiments of the present disclosure;

FIG. 3 is a flow chart of an exemplary implementation of the account growth framework consistent with certain embodiments of the present disclosure;

FIG. 4A is an exemplary customer profile used in the account growth framework consistent with certain embodiments of the present disclosure;

FIG. 4B is an exemplary customer profile including the account history consistent with certain embodiments of the present disclosure;

FIG. 4C is an exemplary customer profile including the customer receptiveness information consistent with certain embodiments of the present disclosure;

FIG. 4D is an exemplary customer profile including customer relationship information consistent with certain embodiments of the present disclosure;

FIG. 4E is an exemplary customer profile including customer relationship information consistent with certain embodiments of the present disclosure; and

FIG. 5 is an exemplary account growth plan consistent with certain embodiments of the present disclosure.

### DETAILED DESCRIPTION

Reference will now be made in detail to the disclosed embodiments, examples of which are illustrated in the accompanying drawings. Wherever possible, the same reference numbers will be used throughout the drawings to refer to the same or like parts.

In this disclosure, a customer account may be a representation of a customer's data and business dealings with a business enterprise that may be associated with one or more account numbers. Account management refers to business activities related to managing data and business dealings related to customer accounts.

An Account Growth Framework (“AGF”) refers to a set of assumptions, concepts, values, and/or practices that constitutes a manner of managing customer accounts with significant growth potential to deliver value to the customer, and to increase sales revenue from the customer account in the process. Significant growth potential may refer to the high projected growth rate (in comparison to competitors or peers in the market) of certain customers, in sales revenue, profit, and/or other aspects of business. A significant business growth cycle may refer to a period of aggressive business expansion and relatively rapid growth of revenue or profit (in comparison to periods of moderate growth, stagnation, or decline). In this disclosure, “growth customer”, “customer with significant growth potential”, and “customer in a significant business growth cycle” are used interchangeably. Value to a customer may refer to any economic or non-economic gain realized by the customer. Such value may be measured by any type of business performance metric, such as quality improvement, reduced cost, increased profit to the customer, etc.

A sales organization may implement the AGF by applying a customized process to selected growth customers, helping the customers achieve their business objectives, and increasing the sales organization's involvement in the customers' business processes. A sales organization may be a sales department within a business enterprise, a dealership, or a network of dealerships. A sales organization may also be a business entity dedicated to selling products and/or services.

A customer account that is managed according to the AGF is referred to as an AGF account. The respective customer is referred to as an AGF customer. A customer may be an individual, a business entity, etc. In this disclosure, “AGF account” and “AGF customer” are used interchangeably. An AGF customer may have one or more AGF accounts.

Business growth objectives may refer to any type of business goal to improve key business results as measured in revenue, profitability, customer satisfaction rating, etc. In this disclosure, “business objectives” and “business growth objectives” are used interchangeably.

In one embodiment, an AGF customer may be a customer with high sales revenue in comparison to other customers (e.g., top 5% measured by sales revenue). The AGF customer may be a market leader in its industry/market who focuses on growing its revenue and profit in the future by deploying new technologies and strategies. The AGF customer may also anticipate significant growth in its business within the next few years based on current market conditions, back orders, etc.

To successfully build a strategic partnership with the AGF customer, the sales organization may prefer to select an AGF customer who is centrally located in the sales organization's sales territory. The sales organization may select an AGF customer from customers who desire a strategic partnership with the sales organization. Such strategic relationship may go beyond a simple vendor/buyer relationship by involving the sales organization in many aspects (procurement, service, project delivery, etc.) of the customer's business. For instance, the AGF customer may need to be willing to outsource a large percentage of its business to the sales organization in the process of building the strategic partnership.

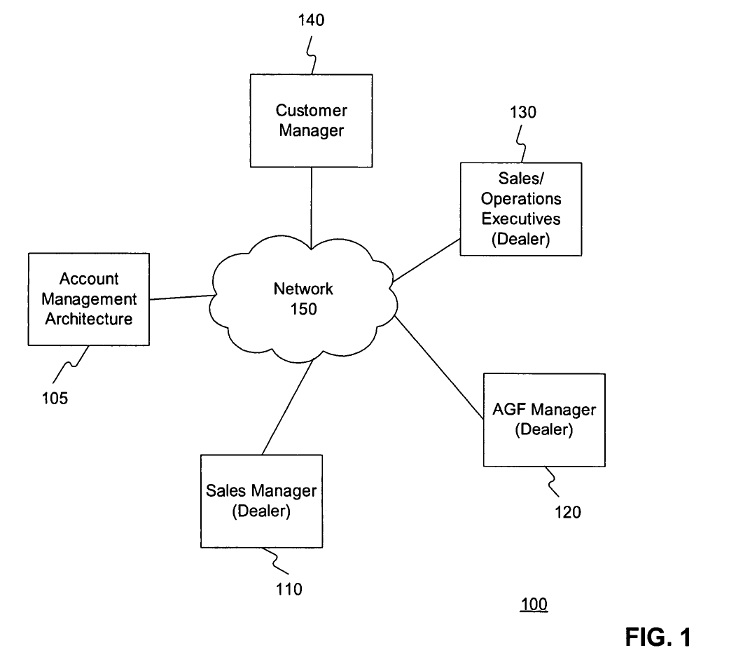

FIG. 1 illustrates an exemplary account management environment 100 consistent with certain embodiments of the present disclosure. As shown in FIG. 1, account management environment 100 may include an account management architecture 105, a sales manager 110, an account growth framework (“AGF”) manager 120, a sales/operations executive 130, a customer manager 140, and a network 150.

Account management architecture 105 may be a system including hardware, software, and/or communication components that facilitate collaboration among the members (e.g., sales manager 110, AGF manager 120, sales/operations executive 130, customer manager 140) of account management environment 100. A member may be any individual, software application, or system within account management environment 100. Account management architecture 105 may also generate, maintain, update, delete, and present customer profile data records, such as sales data related to a customer account. A customer profile data record may include data related to business transactions and/or business relations between a customer and the sales organization using account management architecture 105.

Sales manager 110, AGF manager 120, sales/operations executive 130, and customer manager 140 may each reflect one or more individuals who perform corresponding account management functions in account management environment 100 for a sales organization. Sales manager 110 may be an individual responsible for managing sales revenue of a sales organization, such as a dealership. AGF manager 120 may be an individual responsible for identifying a customer account whose business is entering a significant growth cycle (e.g., with growth potential in sales revenue, profit, etc.) and managing the account according to the AGF (“AGF account”). Sales/operations executive 130 may be an individual with established business relationship with the customer of the AGF account (“AGF customer”). Sales/operation executive 130 may have intimate knowledge of the AGF customer's business plans and projected growth. Customer manager 140 may be a manager in the AGF customer organization. Customer manager 140 may be the liaison for AGF manager 120 in the AGF customer organization.

Sales manager 110, AGF manager 120, sales/operations executive 130, and customer manager 140 may also each represent one or more computer systems or software applications executed by one or more processors configured to perform certain functions related to account management environment 100. These computer systems may each include a memory, a processor, and a display for presenting one or more maps, graphs, messages, etc., consistent with certain disclosed embodiments.

In one embodiment, sales manager 110, AGF manager 120, sales/operations executive 130, and/or customer manager 140 may be related to a dealership selling/distributing products or services (e.g., dealership A). Sales manager 110, AGF manager 120 and sales/operations executive 130 may collaborate to select a group of growth customer accounts (“AGF candidate accounts”) for analysis. Sales manager 110, AGF manager 120, and sales/operations executive 130 may select these AGF candidate accounts from a list of customer accounts of dealership A.

Sales manager 110, AGF manager 120 and sales/operations executive 130 collectively (or independently) analyze information related to the AGF candidate accounts. For example, sales manager 110 may discuss the customers' relationships and their past business dealings with dealership A. Sales/operations executive 130 may share insight related to the business of the AGF candidate accounts, such as business trends in the markets, an AGF candidate account's financial situation, and predictions of future business opportunities and growth for the account.

Based on the detailed analysis of customer information, sales manager 110, AGF manager 120 and sales/operations executive 130 may select an AGF account from the list of AGF candidate accounts. AGF manager 120 may create customer profile records in account management architecture 105 to manage the AGF account information. Sales/operations executive 130 may leverage existing business relationship with the AGF customer (corresponding to the selected AGF account) to set up meetings with one or more decision makers of the AGF customer. A decision maker may be an individual responsible for making decisions regarding business operations of a business entity, such as business operations of the AGF customer, or business operations of a group within the AGF customer organization. Sale/operation executive 130 may also compel the AGF customer to assign a customer manager 140 to collaborate with sales manager 110 and AGF manager 120 in account management activities. Sales manager 110 and AGF manager 120 may organize meetings with one or more decision makers for the AGF customer organization to collect key initiatives and critical success factors for the AGF customer's business objectives. The AGF customer's business objectives may refer to any type of business goal, including expanding present business, entering into a new business, or improving competitiveness and profitability. AGF manager 120 may create a customer profile for the AGF customer in account management architecture 105 to manage customer contact information and communications with the AGF customer.

AGF manager 120 may work with sales manager 110 to develop one or more solutions that would help the AGF customer accomplish its business objectives. A solution may include one or more action items and/or projects that dealership A may perform or execute, such as ordering special machines, schedule maintenance services, etc. A solution may also identify the aspects of the dealer/customer relationship that need to be improved in order to help the AGF customer achieve its business objectives. AGF manager 120 may also work with customer manager 140 to further verify that the proposed solution delivers value to the AGF customer. AGF manager 120 may create an AGF growth plan in account management architecture 105. The AGF growth plan may include information reflecting the proposed solution for the AGF customer and related project management activities, including meeting project or production timeline goals.

AGF manager 120 may monitor the status of action items/projects undertaken according to the proposed solution and the AGF growth plan. AGF manager 120 may have regular meetings with personnel of dealership A to track the progress of action items/projects. AGF manager 120 may also have regular meetings with personnel of the AGF customer to collect data with regard to the progress of action items/projects. AGF manager 120 may communicate with sales manager 110 and customer manager 140 to proactively resolve issues related to the proposed solution and the AGF growth plan. AGF manager 120 may identify additional new AGF customer business opportunities and update the AGF growth plan in account management architecture 105.

Sales manager 110, AGF manager 120, and sales/operations executive 130 may meet periodically with customer manager 140 and other decision makers in the AGF customer organization to provide updates and resolve issues related to the AGF growth plan. Sales manager 110, AGF manager 120, and sales/operations executive 130 may validate the value of the delivered solution with the AGF customer. The value of the delivered solution may be a quantitative value reflecting a measure of how much dealership A's solution helps the AGF customer to achieve its business objectives. AGF manager 120 may determine the value of the delivered solution using measurements of various business metrics such as improved quality, reduced cost, etc. AGF manager 120 may validate the value by presenting the value delivered to decision makers in the AGF customer organization using appropriate business metrics. AGF manager 120 may incorporate feedback and comments from customer manager 140 and other decision makers into the AGF growth plan.

Network 150 may be any type of wireline or wireless communication network for exchanging or delivering information or signals, such as the Internet, a wireless local area network (LAN), or any other network. Thus, network 150 may be any type of communications system. For example, each member of account management environment 100 may pose inquiries or respond to inquiries using network 150.

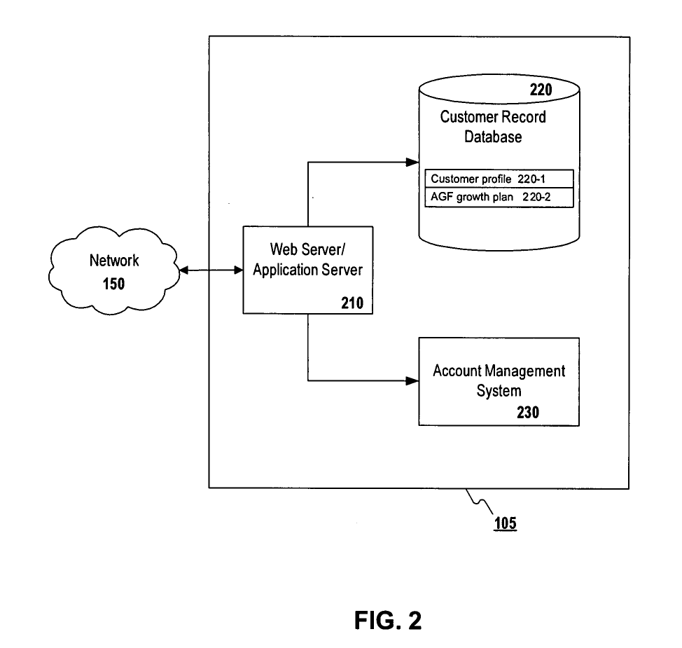

FIG. 2 is a block diagram illustrating an exemplary account management architecture 105. Account management architecture 105 may include a Web server/application server module 210, a customer record database 220, an account management system 230. Web server/application server module 210 interfaces with network 150 and is also connected to customer record database 220 and account management system 230. It is contemplated that account management architecture 105 may include some, all, or additional components illustrated in FIG. 2.

Web server/application server module 210 may include an interface device (e.g., graphical user interface) for a dealer member (sales manager 110, AGF manager 120, or sales/operations executive 130) of account management environment 100 to access customer record database 220, and/or account management system 230. A dealer member of account management environment 100 may manage a customer account by accessing customer and sales data from customer record database 220. Further, web server/application server module 210 may include additional software/hardware components, such as collaboration tools (e.g., Microsoft Exchange Server 2003) that permit members of account management environment 100 to share data and information to work together, bulletin boards to permit members to communicate with each other, and/or search engines to provide efficient access to specific entries in customer record database 220 or account management system 230. One or more memory devices, such as web server/application server module 210 may also permit sales manager 110, AGF manager 120 and sales/operations executive 130 of account management environment 100 to submit records to be added to customer record database 220. Thus, web server/application server module 210 may include one or more software and/or hardware components that enable a user or software process to manage information contained in account management architecture 105. Web server/application server module 210 may include any type of web server and/or application server software, such as Apache HTTP Server from the Apache Software Foundation.

Customer record database 220 may be a system including software executed by a processor that is configured to store customer data and sales data records, charts, entries for changes made to the records, and other information used by members of account management environment 100. Account management architecture 105 may include one or more sales record databases 220.

In one embodiment, a dealership (e.g., dealership A) may use one or more customer record databases 220. Customer record database 220 may include customer profile 220-1 that may include data reflecting a customer's nature of business, transaction history with dealership A, future business plans, and business relationship with dealership A (e.g., contact information of decision makers, etc.). Customer record database 220 may also include AGF growth plan 220-2 that is used to manage an AGF account according to the account growth framework. AGF growth plan 220-2 may include data describing an AGF customer's short term and long term business objectives. AGF growth plan 220-2 may include proposed solutions including action items for dealership A to undertake. AGF growth plan 220-2 may include one or more action plans for managing timeline, tasks, and deliverables related to the action items. AGF growth plan 220-2 may also include a value validation plan that may be used by AGF manager 120 to verify that the proposed solution delivers value to the AGF customer. AGF growth plan 220-2 may also include a customer relationship development plan that may be used to strengthen and expand customer relations with the AGF customer.

Account management system 230 may be a computer system or software executed by a processor that is configured to provide access to data stored in customer record database 220. Account management system 230 may receive one or more requests from a member of account management environment 100 through web server/application server 210. Account management system 230 may define, create, access, update, or delete data records stored in customer record database 220 to perform account management functions as requested by members of account management environment 100.

In one embodiment, AGF manager 120 may use account management system 230 to define or customize templates for customer profile 220-1 and AGF growth plan 220-2, to populate customer profile 220-1 and AGF growth plan 220-2 records for an AGF customer, and to update customer profile 220-1 and AGF growth plan 220-2 in the process of deploying the AGF. Account management system 230 may also present a requested customer profile 220-1 and/or AGF growth plan 220-2 to a member of account management environment 100 through web server/application server module 210.

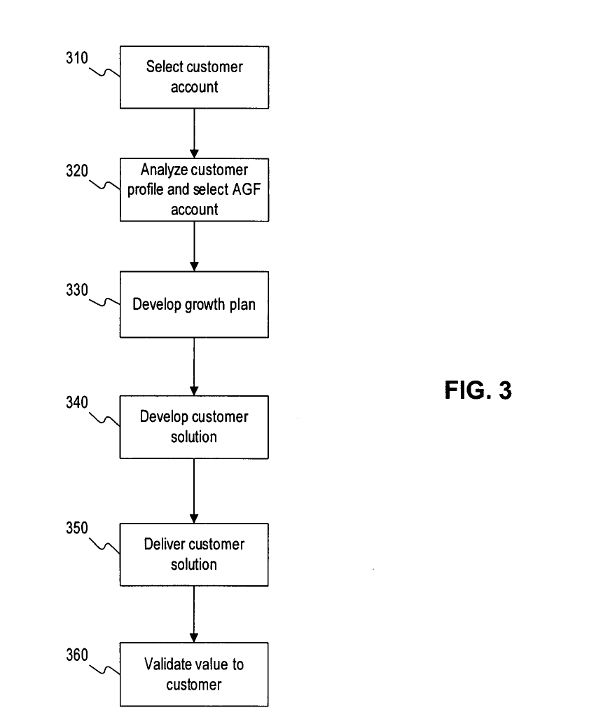

FIG. 3 is a flow chart of an exemplary process for managing a customer account according to the AGF framework. In one embodiment, sales manager 110, AGF manager 120, and/or sales/operations executive 130 may collectively (or independently) select one or more AGF candidate accounts that may have significant growth potential (Step 310). An account with significant business growth potential refers to a customer account that is anticipated to have a higher rate of business growth (e.g., rise in sales revenue, profit margin, etc.) than that of other customer accounts or customers. For example, an account with significant growth potential may be estimated to have an above industry-average increase in the volume of business it will handle in the near future. The customer's business growth potential may be measured by many different business metrics, such as revenue, profit, market share, sales volume, and the like. Sales manager 110, AGF manager 120 and sales/operations executive 130 may select AGF candidate accounts from a list of customer accounts of the sales organization.

AGF manager 120 may create a customer profile 220-1 using account management system 230 for each AGF candidate account. AGF manager 120 may collect data to build a customer profile 220-1 by conducting interviews of sales manager 110, sales/operations executive 130, and of any other persons who have knowledge of the customer's business. Customer profile 220-1 may include data describing the customer's nature of business, its history with the sales organization, its receptiveness to work with the sales organization, and the relationship, such as key contacts, with the sales organization. A customer profile may be represented as a data structure including data reflecting aspects of business operations of the customer.

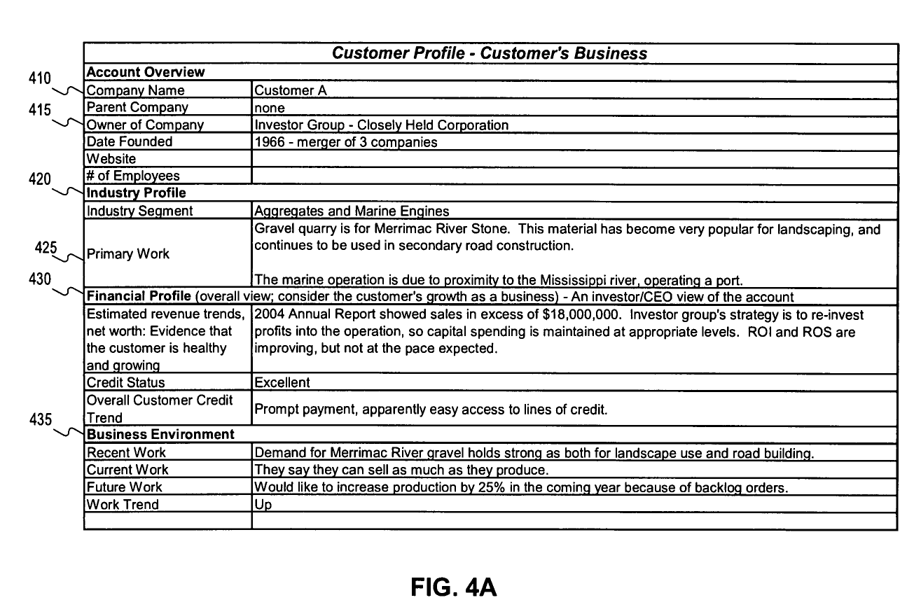

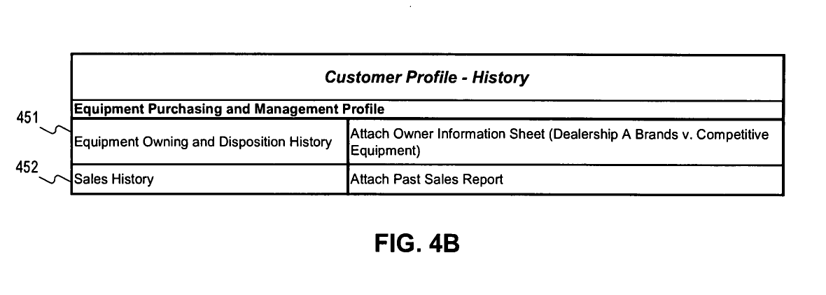

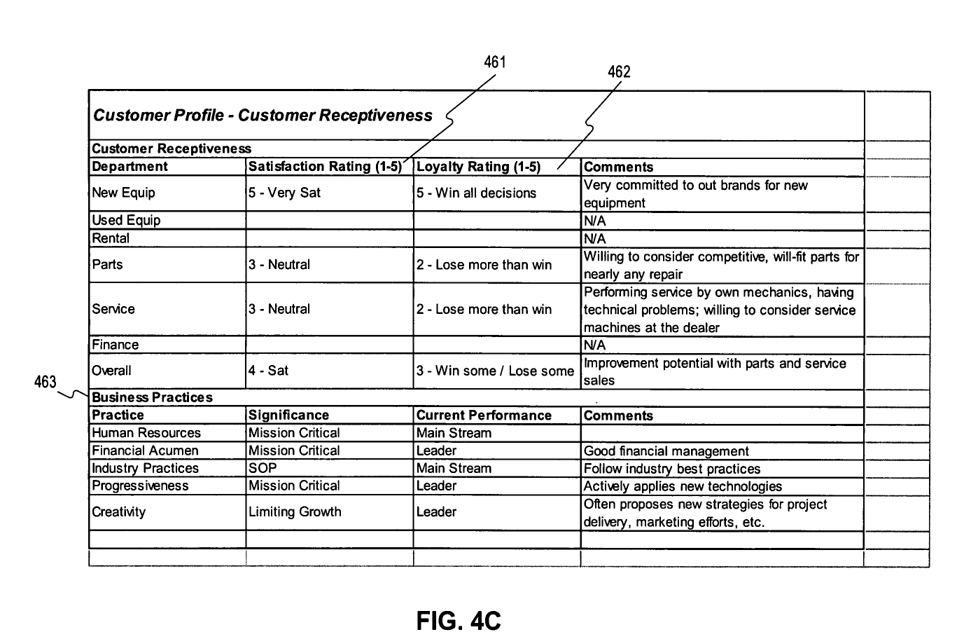

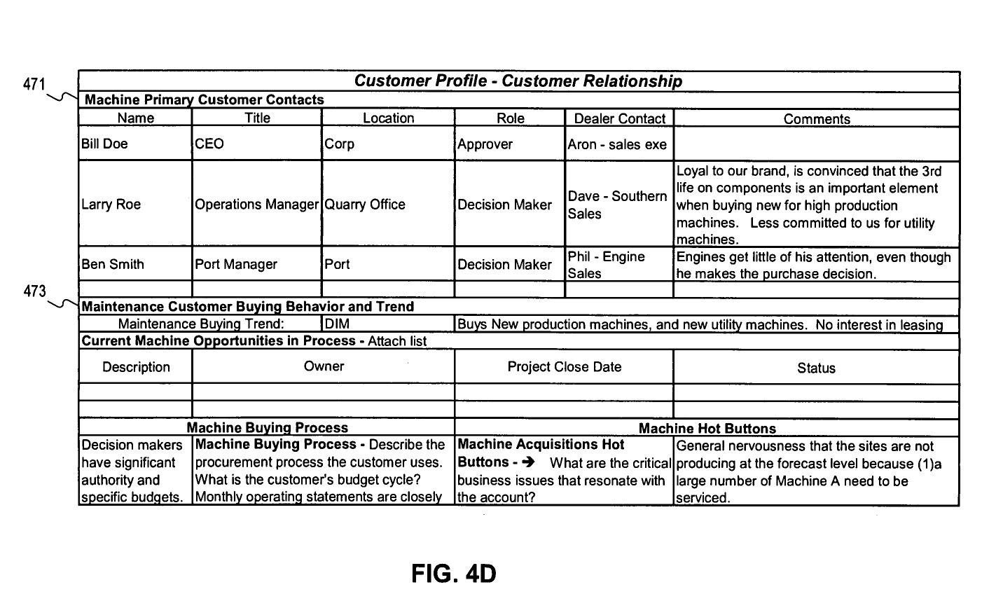

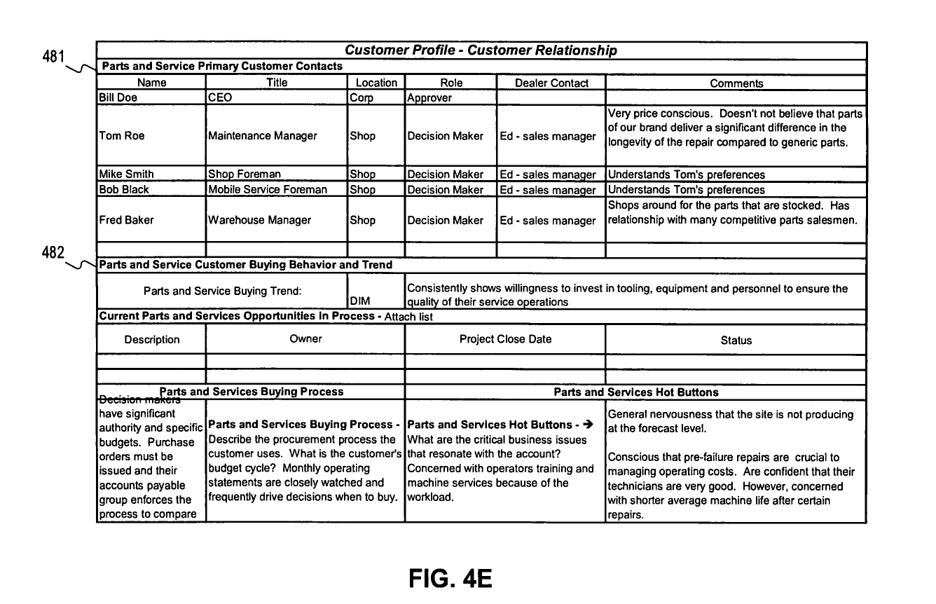

For example, FIGS. 4A-4E illustrate an exemplary customer profile 220-1 consistent with certain disclosed embodiments of the present disclosure. FIG. 4A shows an exemplary customer profile 220-1 including information describing the customer's nature of business. FIG. 4B shows the exemplary customer profile 220-1 including information describing the customer's history with the sales organization. FIG. 4C shows the exemplary customer profile 220-1 including information relating to the customer's receptiveness to work with the sales organization. FIGS. 4D and 4E show the exemplary customer profile 220-1 further including information for business personnel contacts and processes of the customer organization.

In one embodiment, sales manager 110, AGF manager 120 and sales/operations executive 130 may work for a dealership (e.g., dealership A). Sales manager 110, AGF manager 120, and sales/operations executive 130 may select AGF candidate accounts from a list of customer accounts. AGF manager 120 may create customer profile 220-1 in account management system 230 to document information related to an AGF candidate account.

As shown in FIG. 4A, sales manager 110, AGF manager 120, and sales/operations executive 130 may identify Customer A 410 as an AGF candidate account. Sales/operations executive 130 may provide business information regarding Customer A 410, such as ownership information 415, industry profile 420, primary work 425, financial profile 430, business environment 435, and the like. As shown in FIG. 4B, sales manager 110 may provide Customer A 410's past ownership information 451 and past sales reports 452. As shown in FIG. 4C, sales manager 110 and/or sales/operations executive 130 may further provide information regarding Customer A 410's receptiveness to work with dealership A. The receptiveness data may include Customer A 410's satisfaction rating 461 and loyalty rating 462. Satisfaction rating 461 may include data reflecting whether Customer A 410 is satisfied with regard to past business dealings with dealership A. Loyalty rating 462 may include data reflecting whether Customer A 410 is likely to conduct more business with dealership A in the future. The receptiveness information may also include business practices 463 information indicating whether Customer A 410 follows best practices in the industry. Best practices refer to proper processes a business can apply to conduct its operations so that it can deliver products and services with fewer problems and unforeseen complications. Sales manager 110 and sales/operations executive 130 may also provide relationship information for Customer A 410. As shown in FIGS. 4D and 4E, the relationship information may include key contact information, such as primary contact for machine purchase 471 (FIG. 4D) and for maintenance and services 481 (FIG. 4E). Sales/operations executive may also provide information regarding Customer A 410's buying process 473 (FIG. 4D), and the like. AGF manager 120 may gather data for customer 220-1 from sales manager 110, sales/operations executive 130, and from any other persons who work for or work with Customer A.

Referring back to FIG. 3, after collecting customer profile data for the AGF candidate accounts, sales manager 110, AGF manager 120, and sales/operations executive 130 may analyze the AGF candidate accounts to select, or designate, an AGF customer (step 320). Sales manager 110, AGF manager 120, and sales/operations executive 130 may review and analyze detailed information in customer profile 220-1 for each identified AGF candidate account.

Sales manager 110, AGF manager 120, and sales/operations executive 130 may quantify potential revenue and profit opportunities for the sales organization based on information in customer profile 220-1. To ensure the realization of such opportunities, Sales manager 110, AGF manager 120, and sales/operations executive 130 may also verify that the selected customer has an overall objective (consistent with the sale's organization's vision) to significantly improve or grow its business. As such, sales manager 110, AGF manager 120, and sales/operations executive 130 may select an AGF customer with high revenue/profit opportunity (for the sales organization), and with an overall objective to grow its (the customer's) business.

Further, the sales organization (e.g., AGF manager 120 and sales/operations executive 130) may select an AGF customer who is interested in developing a strategic relationship by sharing information related to the customer's performance goals and related business metrics. The sales organization may measure the value delivered to the AGF customer based on the customer's performance goals and metrics. Moreover, because an AGF customer requires customized relationship and sales management support, the sales organization may evaluate whether the potential return is worth the investment in the customer.

In the Customer A 410 example described above, as shown in FIG. 4A, sales manager 110, AGF manager 120, and sales/operations executive 130 may analyze Customer A's growth potential based on data collected from personnel of Customer A. For example, through interviews, AGF manager 120 may collect information indicating that Customer A 410 would likely to increase its production by 25% in the coming year because of existing back orders. AGF manager 120 may record the collected information in Customer A's business environment data 435. AGF manager 120 may conclude that Customer A 410 has significantly increased demand for machines and services in the near future.

Sales manager 110, AGF manager 120, and sales/operations executive 130 may analyze Customer A's sales history. For example, Customer A's sales reports 452 in FIG. 4B may show consistent growth of spending on machines over the past three years (not shown in FIG. 4B). In this example, based on data from Customer A's sales reports 452, AGF manager 120 may determine that Customer A 410 had strong growth in the past, and would likely keep growing based on history and current indicators (e.g., economy, business, sales, etc.).

AGF manager 120 and/or sales/operations executive 130 may further analyze the receptiveness information including Customer A 410's business practices 463 (FIG. 4C). As explained earlier, receptiveness data may be collected from personnel of Customer A. Receptive data may include satisfaction rating 461 indicating whether Customer A 410 is satisfied with dealership A in past dealings; receptiveness data may also include loyalty rating 462 indicating whether Customer A 410 is likely to conduct more business with dealership A in the future; receptiveness data may further include business practice rating 463 indicating whether Customer A 410 follows industry best practices. As shown in FIG. 4C, Customer A 410's business practices 463 may show that Customer A 410 follows industry best practices and approaches problems with creative solutions. Based on satisfaction rating 461, AGF manager 120 may conclude that Customer A 410 is satisfied in past dealings with dealership A. Based on loyalty rating 462 AGF manager 120 may conclude that Customer A 410 is committed to conduct more business with dealership A in the future because Customer A 410 is very loyal to the machine brand carried exclusively by dealership A. AGF manager 120 may also note from loyalty rating 462 that dealership A has potential to increase sales revenue with Customer A 410 because it has lost rather than gained sales in parts and services to competitors. Based on receptive data as shown in FIG. 4C, AGF manager 120 may determine that Customer A 410 is receptive to work with dealership A.

Sales manager 110 and/or sales/operations executive 130 may analyze relationship information of Customer A 410 based on data collected from interviewing personnel of Customer A. As shown in FIG. 4D, Customer A 410 may only purchase new machines, and may not be interested in leasing or rental (473—maintenance buying trend). Further, as shown in FIG. 4E, Customer A 410 may be willing to invest in tooling and equipment to ensure the quality of its work (482).

As such, AGF manager 120 may determine that Customer A 410 has significant revenue growth potential in the coming years (FIG. 4A—435), and is receptive to develop business relationship with dealership A (FIG. 4C). Further, the analysis may show that dealership A may have potential to gain significant sales revenue in service and parts sales, because Customer A 410 currently purchases more parts and services from competitors (FIG. 4C—462). Sales manager 110, AGF manager 120, and sales/operations executive 130 may therefore select Customer A 410 as an AGF customer, and assign AGF manager 120 to manage the account.

In another embodiment, sales manager 110, AGF manager 120, and sales/operations executive 130 may first collect customer profile data such as that shown in FIGS. 4A-4E for AGF candidate accounts. AGF manager 120 may use worksheets, templates, and/or software programs in account management system 230 to rank the AGF candidate accounts based on various business metrics (e.g., revenue growth potential, customer relationship strength, etc.). AGF manager 120 may then select an AGF customer from the AGF candidate accounts based on the rankings of the AGF candidate accounts.

After selecting the AGF account and identifying the corresponding AGF customer, AGF manager 120 may leverage existing customer relationship to capture the AGF customer's business objectives and to develop an account growth plan 220-2 (step 330). AGF manager 120 may organize meetings and interviews using existing customer contacts to further collect data reflecting the customer's business objectives.

AGF manager 120 may create an AGF growth plan 220-2, using templates defined according to the AGF framework, in account management system 230. A template for AGF growth plan may include data fields for customer objectives, initiative undertaken by the sales organization for the customer, customer's critical success factors, the sales organization's vision of the relationship, the sales organization's value statement, etc. Such information may help the sales organization to determine its roles and responsibilities in addressing the AGF customer's critical success factors and helping the AGF customer achieve its business growth objectives.

AGF manager 120 may document customer business objectives in the AGF growth plan 220-2 based on data collected from the sales organization and the customer. AGF manager 120 may track related management activities, such as meeting plans and other planned interactions with the customer in the AGF growth plan 220-2. In one embodiment, AGF manager 120 may also document, in a customer relationship plan (as a part of AGF growth plan 220-2), the understanding of the customer's vision, key initiatives, critical success factors, and the solutions proposed by the sales organization to enable and support the customer to achieve its business growth objectives, etc.

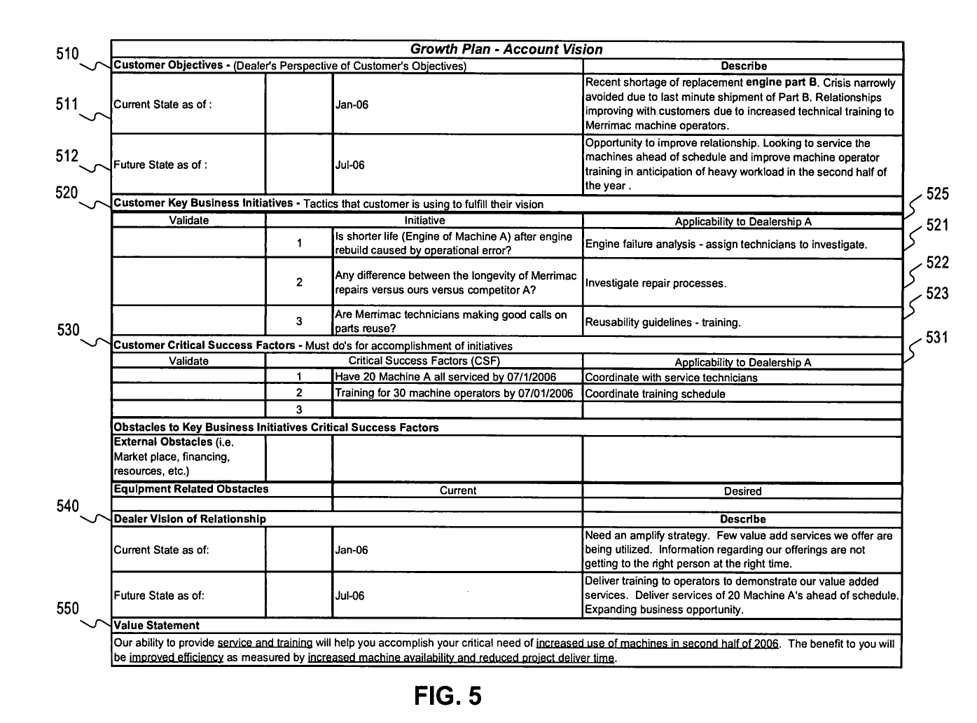

FIG. 5 illustrates an exemplary AGF growth plan 220-2 for Customer A 410 consistent with certain disclosed embodiments of AGF framework. As shown in FIG. 5, AGF growth plan 220-2 may include customer objectives 510, initiatives undertaken 520 by the sales organization for the customer, customer's critical success factors 530, the sales organization's vision of the relationship 540, and the sales organization's value statement 550.

Referring back to the Customer A 410 example described above, AGF manager 120 may use existing customer contacts (shown in FIGS. 4D-4E) to set up meetings with decision makers of Customer A 410 to verify the company's short term/long term business objectives 510. Through meetings with decision makers, AGF manager 120 may document and revise dealership A's understanding of Customer A 410's business growth objectives. For example, as shown in the current state of customer objectives 511, Customer A 410 had a shortage of engine part B in the previous year (2005), which almost delayed their project completion dates. Further, as shown in the future state of customer objectives 512, Customer A 410 anticipates unusually heavy workload for the second half of 2006, and therefore one of Customer A 410's objectives is to ensure that it can handle the increased workload. Accordingly, Customer A 410 may plan to perform maintenance services for machines before July 2006. Performing maintenance services before July 2006 may thus be a critical success factor. AGF manager 120 may document the critical success factor in growth plan 220-2 (e.g., customer critical success factor 530).

Further, AGF manager 120 may meet with decision makers, such as parts and services primary customer contacts 481 (FIG. 4E—Tom, Mike, Bob, etc.), to identify each decision maker's ongoing projects and initiatives and related critical success factors. For example, maintenance manager Tom Roe and warehouse manager Fred Baker may indicate that the engine of machine A has a shorter average machine life after the engine is being rebuilt by Customer A 410's technicians. Thus, an identified project may be resolving the machine life issue. AGF manager 120 may document this project in growth plan 220-2 (e.g., customer key business initiatives 520).

Returning to FIG. 3, after capturing the AGF customer's objectives and critical success factors, AGF manager 120 may further develop a solution (“AGF solution”) addressing the AGF customer's needs (step 340). To develop the AGF solution, AGF manager 120 may need to understand the causes of problems and obstacles to meet the AGF customer's business growth objectives. AGF manager 120 may use project management tools, such as Microsoft Project, to track the status of action items and initiatives defined in the AGF solution.

The AGF solution may include actions and initiatives for the sales organization, i.e., the roles and responsibilities for the teams of the sales organization. AGF manager 120 may consider the sales organization's capabilities and resource capacity in the process of developing the solution. AGF manager 120 may collect information regarding the AGF customer's budget, manpower, critical scheduling and production timetables, and similar information, and develop the solution to meet these requirements. AGF manager 120 may also identify business metrics that can be used to measure the value of the AGF solution.

Further, AGF manager 120 may develop the solution based on information regarding offers made by competitors (of the sales organization) to the AGF customer. AGF manager 120 may differentiate between the sales organization's offer and a competitor's offer to the customer. AGF manager 120 may also verify the understanding of the AGF customer's approval process in preparation for delivering the solution. AGF manager 120 may organize meetings with the AGF customer (e.g., customer manager 140) to communicate and verify the differentiating features of the AGF solution, the resources required from the sales organization and the AGF customer, and the business metrics used to measure the value of the AGF solution according to AGF growth plan.

For example, based on maintenance manager Tom Roe and warehouse manager Fred Baker's input (FIG. 4E—engine has a shorter average machine life being rebuilt by Customer A), AGF manager 120 may decide that dealership A may execute initiative 521 (FIG. 5) to help Customer A 410 resolve the machine life issue. AGF manager 120 may also identify other initiatives, such as 522 and 523, for dealership A.

As explained above, AGF manager 120 may identify critical success factors 530 for Customer A 410, such as having a relatively large number of machine A serviced by July of 2006, based on input from Customer A 410. AGF manager 120 may also determine actions items 531 for dealership A related to the success factors. By conducting periodic meetings with Customer A, AGF manager 120 may verify that business initiatives 520 and critical success factors 530 accurately reflects Customer A 410's needs. The identified dealership A initiatives 525 and action items 531 may be referred to as the AGF solution for Customer A 410. AGF growth plan 220-2 for dealership A may include an action plan containing project management activities (e.g., managing staffing, timeline, status, etc.) related to initiatives 525 and action items 531. AGF manager 120 may use the action plan to monitor and control the progress of initiatives 525 and action items 531.

Next, AGF manager 120 may deliver the AGF solution to the AGF customer by carrying out dealership A initiatives 525 and action items 531 (step 350). AGF manager 120 may coordinate activities across all groups (of the sales organization) involved in delivering the AGF solution, and have periodic meetings with sales organization personnel to monitor the status of initiatives and action items undertaken by the sales organization according to the AGF solution. AGF manager 120 may ensure that the initiatives 525 and action items 531 are completed within both the sales organization's and the AGF customer's budget, manpower, critical scheduling and production timeline requirements.

AGF manager 120 may work with personnel of dealership A and Customer A 410 to identify issues (e.g., potential causes for delay in completing projects) in the delivered solution. Through regular meetings and interviews of personnel of the AGF customer, AGF manager 120 may identify and incorporate additional areas to provide value to the AGF customer. AGF manager 120 may update the AGF growth plan 220-2 to reflect information collected at these meetings.

Referring to the AGF growth plan 220-2 shown in FIG. 5, AGF manager 120 may use a project management tool (e.g., Microsoft Project) to track the status of dealership A initiatives and action items related to Customer A 410. For example, AGF manager 120 may coordinate with service department of dealership A to ensure that dealership A can complete the maintenance service jobs for 20 machine As before July 2006 (as defined in 530 and 531). AGF manager 120 may create a project plan to perform services for four machine As monthly for the first five months of 2006. AGF manager 120 may track the progress of the project through regular meetings with dealership A personnel working on the project. AGF manager 120 may also track the progress of the project through regular meetings with Customer A personnel working on tasks related to the project.

After delivering the solution to the AGF customer, AGF manager 120 may validate the value delivered to the AGF customer in light of its business objectives through periodical meetings with the customer (step 360). AGF manager 120 may gather business metrics for value measurements. Such business metrics may include measures of productivity improvements, cost savings, product improvements, increased machine availability, etc. The delivered value may also be measured by customer satisfaction metrics including machine operator satisfaction ratings, turnaround time (e.g., for machine repairs), overall financial results, etc. The method that is used to measure improvement and delivered value may be agreed to by both the sales organization and the AGF customer, and included in the AGF growth plan. AGF manager 120 may meet with the AGF customer to demonstrate that the delivered solution helped the AGF customer achieve its business objectives.

AGF manager 120 may create a value validation plan that may be included in the AGF growth plan 220-2. The value validation plan may include information used by AGF manager 120 to determine the value of a delivered solution. The value validation plan may also include meeting schedules, contact information, etc., which AGF manager 120 may use to communicate the value of the delivered solution to the AGF customer.

For example, AGF manager 120 may gather data reflecting the amount of downtime and the number of repairs for machine A for each month of 2004, 2005, and 2006. By completing the maintenance services before schedule (i.e., before July 2006), AGF manager 120 may determine that the downtime of machine A and the average number of repairs of machine A may be significantly reduced for the second half of 2006. AGF manager 120 may also track the positive impact on Customer A 410's overall project performance resulted from improved availability of machine A (e.g., reducing one day in completing job A, and therefore reducing the total completion time by one day). According to the value validation plan, AGF manager 120 may communicate and/or present the value delivered to Customer A 410's decision makers in regular meetings. Additionally, AGF manager 120 may organize and attend executive meetings between dealership A and Customer A 410 to present value delivered by dealership A.

AGF manager 120 may also report the AGF customer's account growth measured by business metrics of the sales organization (e.g., dealership A). Such measurements may include increased sales revenue, improved profit margin, projected sales revenue, increased customer satisfaction, increased customer loyalty, elimination of competitive bids by the customer, etc., for the sales organization (e.g., dealership A).

### INDUSTRIAL APPLICABILITY

Methods and systems consistent with the disclosed embodiments may enable a business to implement customer centric business processes so that the business would deliver value specific to each growth customer's business objectives. In one embodiment, a business manager may use an account management system to manage customer data, and managing business processes related to customer accounts. For example, the manager may identify AGF candidate accounts with growth potential. The manager may analyze customer profile data and identify an AGF customer which applies industry best practices, and implements such practices to grow its business. The manager may meet with the AGF customer's decision makers to understand and verify the customer's business objectives. The manager may develop account growth plans, and identify a solution with action items, projects, and timelines to help the AGF customer achieve its business objectives. The manager may assign the identified action items and projects across many groups and departments within the business enterprise, and monitor the status of the action items and projects. The manager may also deliver solution to the AGF customer and confirm the value delivered to the AGF customer.

Methods and systems consistent with the disclosed embodiments may also enable a business enterprise to take a customer centric approach in its internal operations. For example, a business enterprise may design its Enterprise Resource Planning (ERP) systems with a customer centric approach. The account growth framework may be used to facilitate development of ERP systems. The systems developed following the account growth framework may orchestrate all customer related tasks across departmental boundaries, while providing user interfaces reflecting each customer's business objectives and customer specific solutions.

Methods and systems consistent with the disclosed embodiments may further enable business enterprises to obtain customer intelligence across multiple groups and departments. For example, the account management system may be used to gather customer profile data from sources across multiple internal groups and departments. The account management system may also be used to gather customer profile data from personnel of the customer organization. With more comprehensive customer profile data, a business can make faster and better decisions.

It will be apparent to those skilled in the art that various modifications and variations of the disclosed embodiments can be made. Additionally, other embodiments of the disclosed methods and systems will be apparent to those skilled in the art from consideration of the specification. It is intended that the specification and examples be considered as exemplary only, with a true scope of the disclosure being indicated by the following claims.

What is claimed is:

1. A method for managing growth customer accounts, the method including:
analyzing a customer profile, the customer profile being based on data collected from a respective customer;
designating an AGF customer based on at least the analysis;
identifying at least one business objective of the AGF customer;
developing an AGF growth plan including a solution to help the AGF customer achieve the at least one business objective;
delivering the solution to the AGF customer according to the AGF growth plan; and
determining a value of the delivered solution in helping the AGF customer achieve the at least one business objective.

2. The method of claim 1, wherein the customer profile includes data describing one or more business processes related to the customer.

3. The method of claim 1, wherein the solution includes one or more action items, and the AGF growth plan includes project management activities related to the one or more action items.

4. The method of claim 3, wherein delivering the solution includes executing action items and managing progress of the one or more action items.

5. The method of claim 1, further including:
collecting one or more business metrics from the AGF customer to measure the value of the delivered solution.

6. The method of claim 5, further including:
presenting the value of the delivered solution based on the one or more business metrics.

7. The method of claim 2, wherein the AGF growth plan includes a customer relationship development plan and a value validation plan for the AGF customer.

8. A computer system for managing customer accounts, the system including:
a processor; and
a memory storing data including customer profile records, wherein the processor is configured to:
receive a customer profile included in the memory;
receive a designation of an AGF customer based on at least the analysis;
receive at least one business objective of the AGF customer;
receive an AGF growth plan including a solution to help the AGF customer achieve at least one business objective;
receive status information related to the solution for the AGF customer; and
provide a value of the delivered solution in helping the AGF customer achieve the at least one business objective.

9. The system of claim 8, wherein the customer profile includes data describing one or more business processes related to the customer.

10. The system of claim 8, wherein the solution includes one or more action items, and the AGF growth plan includes project management activities related to the one or more action items.

11. The system of claim 10, the processor is further configured to:
receiving a status update for the one or more action items based on information received from the AGF customer.

12. The system of claim 8, the processor is further configured to:
receive one or more business metrics from the AGF customer to measure the value of the delivered solution.

13. The system of claim 12, the processor is further configured to:
display the value of the delivered solution based on the one or more business metrics.

14. The system of claim 9, wherein the AGF growth plan includes a customer relationship development plan and a value validation plan for the AGF customer.

15. A computer-readable medium containing instructions to configure a processor to perform a method for managing customer accounts, the method including:
receiving a customer profile, the customer profile being based on data collected from a respective customer;
receiving a designation of an AGF customer based on the customer profile;
receiving at least one business objective of the AGF customer;
receiving an AGF growth plan including a solution to help the AGF customer achieve the at least one business objective;
tracking progress of the solution to the AGF customer according to the AGF growth plan; and
providing a value of the delivered solution in helping the AGF customer achieve the at least one business objective.

16. The computer medium of claim 15, wherein the customer profile includes data describing one or more business processes related to the customer.

17. The computer medium of claim 15, wherein the solution includes one or more action items, and the AGF growth plan includes project management activities related to the one or more action items.

18. The computer medium of claim 15, wherein tracking progress of the solution further includes receiving an action plan, the action plan including project management activities related to one or more action items, and tracking progress of the one or more action items within the plan.

19. The computer medium of claim 15, further including:
receiving one or more business metrics from the AGF customer to measure the value of the delivered solution.

20. The computer medium of claim 19, further including:
displaying the value of the delivered solution based on the one or more business metrics.
